(19) United States
(12) Patent Application Publication
(10) Pub. No.: US 2023/0051686 A1
(43) Pub. Date: Feb. 16, 2023

(54) MULTI-FORMAT BINGO GAME

(71) Applicants: Craig K. Potts, Scottsdale, AZ (US); Justin Crawford, Scottsdale, AZ (US)

(72) Inventors: Craig K. Potts, Scottsdale, AZ (US); Justin Crawford, Scottsdale, AZ (US)

(21) Appl. No.: 17/444,992

(22) Filed: Aug. 12, 2021

(51) Int. Cl. A63F 3/06; G07F 17/32; G07F 17/42

(52) U.S. Cl. CPC A63F 3/0645; G07F 17/42; G07F 17/3211; G07F 17/3227; G07F 17/3232

(57) ABSTRACT

To provide additional options for players, a system is provided that allows for the play of multiple types of bingo games and further allows for the play of bingo games in multiple formats. A central controller coordinates operation of the bingo game so that play can be carried out on a gaming machine, on an electronic bingo gaming device, via electronic devices, in paper format, etc. Further, the central controller coordinates the play different types of bingo games with variable payout, variable winning patterns and variable side games. Each format further allows for a user to play multiple cards at a single time, thus providing further winning opportunities. Additionally, traditional ball drop mechanisms can be used during play to add to the entertainment experience by having numbers drawn using a bingo balls drop mechanism, or be selected via a tumbler, or other selection device. The resulting selections are then communicated to the central controller for use in the multi-format bingo game.

### BACKGROUND

In the gaming industry, providing new entertainment options and opportunities for individuals can be an ongoing challenge. One portion of this activity is the creation of new games, which increases the number of options and opportunities available for users. Further, creating games that are easy to understand while also interesting can always be challenging and rewarding at the same time.

Bingo is a well-known game which is easily understood and recognized by many different participants, and which can be easily incorporated in both an electronic version or a paper version. Bingo halls have existed for many years and continue to provide both entertainment and fundraising options for several users and organizations. That said, variations and further modifications of well-known bingo games provides additional reasons for users and/or participants to remain interested. As such, modifications to the well understood bingo game are well received and often anticipated when introduced.

### SUMMARY

To provide additional variety, a coordinated system utilizes several different components in communication with one another and capable of carrying out multiple bingo games simultaneously, while also allowing for play in multiple formats. A central processing system manages operations of the overall bingo system, which includes the promotion, setup, play and prize payout steps of the various games involved. The central controller will accommodate the sale of physical bingo cards, which can be purchased by a user in both a physical (i.e. printed) format, or an electronic format. Integrated within the central controller, or cooperating with the central controller, is a point of sale system, which allows for the logistics of selling bingo cards via many purchase options. Also cooperating with the central controller are display devices, which will display numbers or balls being drawn, display possible winning patterns for the games involved, or other information necessary for the play of the desired bingo games. Also associated with the central controller is a printer capable of printing paper bingo cards. Using the paper bingo cards, play can be carried out either physically, or via the use of an electronic bingo unit, capable of tracking the card layout and monitoring progress as the game is played.

The central controller can also allow players to monitor balances in accounts, using appropriate login and/or pin information. It is further contemplated that central controller will have the ability to carry out the logistics of playing the bingo game internally, or may receive input from a live ball count device, or physical ball count operations carried out by operators. As play of the various bingo games is tracked, central controller will also monitor prize winnings, and coordinate potential payouts. In those circumstances where electronic bingo cards are to be purchased, the central controller is able to issue or print appropriate access information, so that cards can be retrieved via a separate electronic bingo unit, which is capable of communicating with central controller during the play of the necessary bingo game or games.

Significantly, central controller is also capable of coordinating multiple bingo games simultaneously. This provides a user with several options and variations. These and other advantages are provided by a comprehensive overall controlled system.

### BRIEF DESCRIPTION OF THE DRAWINGS

Further advantages and features will be apparent from reading the following description in conjunction with the drawings, in which:

FIG. 1 is a diagram illustrating the overall layout of the game system;

FIG. 2 is a front view of a gaming terminal capable of carrying out the game play functions of the disclosed embodiments;

FIG. 3 is a game selection menu providing a user with game options;

FIGS. 4A through 4C illustrate three game variations capable of being played by the system disclosed herein;

FIGS. 5A and 5B illustrate winning patterns utilized in the bingo game of a disclosed embodiment;

FIGS. 6A and 6B illustrate a printed version of the bingo cards accommodating manual play by users;

FIGS. 7A and 7B illustrate ball drop display options for the certain embodiments;

FIG. 8 is an administrator interface allowing for coordinated operation of the bingo games of the disclosed embodiments;

FIGS. 9A and 9B illustrate administrative screens coordinating the ball drop steps;

FIG. 10 shows various ball blower options for the bingo system disclosed herein.

### DESCRIPTION

Electronic gaming machines have existed for long periods of time, dating back to the original slot machine and more currently including several types of video gaming devices. In the gaming industry, there is a constant desire to develop new and interesting gaming options for users, thus providing variety and many different types of enjoyment for players. Again, bingo games have existed for long periods of time and are enjoyed by many different people due to the straightforward nature of the bingo game. Further many variations, options or alternatives that can be incorporated, which adds to the user experience.

As set forth below, the present gaming system provides the ability to incorporate and conduct many different bingo games, while also allowing users to participate in multiple formats. More specifically, the gaming system described herein provides the ability for users to participate in bingo games of many different types using an electronic gaming unit, paper bingo cards, a gaming cabinet or a combination thereof. This opens up opportunities for bingo games to be played in many settings, and by many different players. As will be apparent from the discussion below, the multiple play options provided by the disclosed embodiments allow equal opportunities for all people to participate in bingo games. For example, people with disabilities can more easily participate using paper cards or a stand-alone electronic gaming device. This can be also true for others who would not otherwise participate in electronic bingo games.

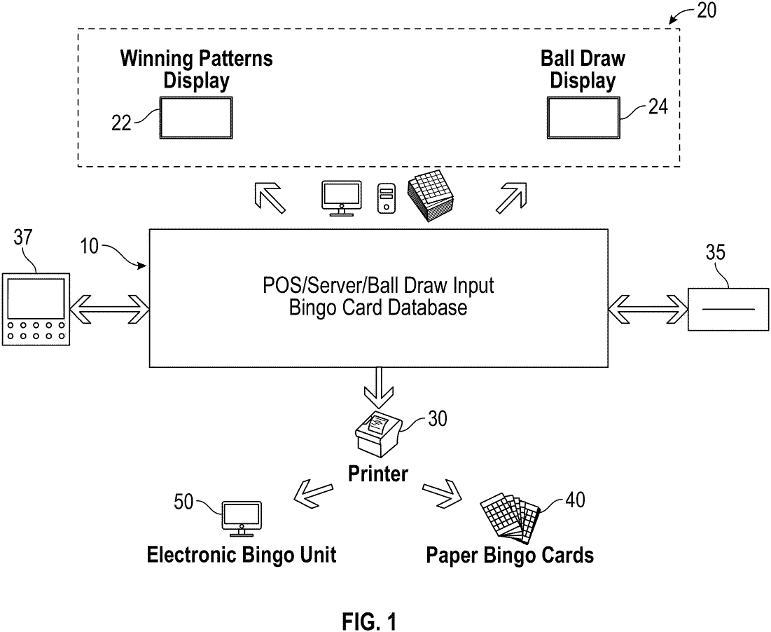

Turning now to FIG. 1, a system diagram illustrates the general concepts and components of the gaming system described herein. Central to the gaming system itself is a central controller 10 which will coordinate/manage activities and will implement the bingo games themselves. Central controller 10 communicates with a display system 20 which, in this embodiment, includes a first display 22 and a second display 24. As will be appreciated, display system 20 could include multiple displays, or a single large display capable of communicating and presenting desired information. In the embodiment contemplated, it is expected that first display 22 will present a winning pattern presentation, thus advising players of the winning patterns available for wins in the bingo game being played. Similarly, second display 24 will present the ball drop or ball draw presentation, thus allowing participants or players to track and follow the bingo game as it progresses.

Also communicating with central controller 10 is a printer 30 which carries out a number of functions including the printing of paper/printed bingo cards 40, while also printing necessary receipts and/or codes which allow for activation of an electronic bingo unit 50. As suggested above, it is contemplated that users may be able to participate in the bingo games using printed paper cards 40, the electronic bingo unit 50, or a gaming cabinet 60 (not shown in FIG. 1), which is configured to provide a user interface thus allowing participants to play the bingo game itself.

As illustrated in FIG. 1, central controller 10 is connected to various devices, and carries out various functions to coordinate overall bingo play. As one example of this, physical bingo cards can be purchased and/or redeemed via central controller 10. These physical cards or paper bingo cards 40 are printed via printer 30, while a scanning device 35 is utilized to redeem cards once play is finished. Scanning device 35 can be a scanner of any type, or could be an input device utilized to input codes printed on paper bingo cards 40. As contemplated, this will allow central controller 10 to verify that the bingo cards involved are authentic and include winning combinations. Central controller 10 will then have appropriate mechanisms to provide payouts, and/or credits as appropriate for the particular institution involved. These payout mechanisms could include bill exchangers, or printers capable of generating vouchers or payment tickets. Alternatively, a player’s loyalty card, and related house accounts could be utilized to generate or provide appropriate winning amounts.

Central controller 10 may also maintain records of existing player accounts, and thus allow for the monitoring, and maintenance of these player accounts as directed via a user interface 37. User interface 37 could take on many forms, including a separate unit having a keypad and individual display, a touchscreen, or could be an integrated device within central controller 10.

As also illustrated in FIG. 1, the system contemplates the use of electronic bingo unit 50. In this embodiment, electronic bingo unit 50 is a standalone or separate unit capable of receiving electronic bingo cards, and accommodating the related play of the desired bingo game. In one embodiment, central controller 10 will issue account information or specific codes capable of allowing electronic bingo unit 50 to download the necessary electronic bingo cards. A user may then use electronic bingo unit 50, to enter the necessary codes or information, and thus allowing related bingo cards to be available for play. Alternatively, other embodiments may include a direct wireless connection between electronic bingo unit 50 and central controller 10, which allows for bingo cards to be obtained and/or accessed via appropriate login credentials or code information.

It is contemplated that central controller 10, user interface 37, scanner 35, printer 30, first display 22 and second display 24 could all be housed within a stand-alone gaming machine thus allowing the bingo game to be played in various formats, including several of the examples outlined below. Alternatively, a networked solution is possible where central controller 10 will coordinate with multiple gaming machines, so that multiple players can participate using the same number selection process (i.e. one ball drop, or following a single tumbler-based selection process).

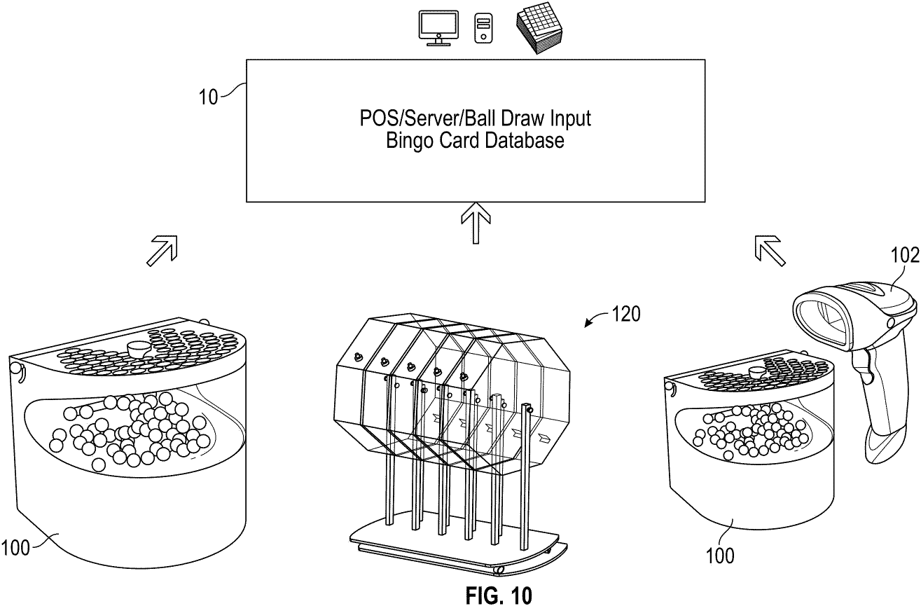

As mentioned, central controller 10 is capable of receiving inputs or coordinating operation of external bingo call devices. This may include automated ball drop machines, manual tumblers along with manual inputs provided to central controller 10, or automated ball drop mechanisms with related scanning and communication equipment. Several of these devices are illustrated and discussed in detail below in relation to FIG. 10. As will be discussed in further detail below, central controller 10 has mechanisms, and connections to allow an administrator to set various gaming parameters and dictate which types of bingo games are capable of being played within the present system.

Again, playing bingo games in various formats provides different experiences and different levels of interest for the users themselves. Those familiar with typical bingo cards or paper bingo cards will enjoy the activity of maintaining and marking their cards. Similarly, those more comfortable with electronic apparatus can utilize a gaming cabinet, or an electronic bingo unit 50. By providing these multiple options, several levels of interest and entertainment are achieved.

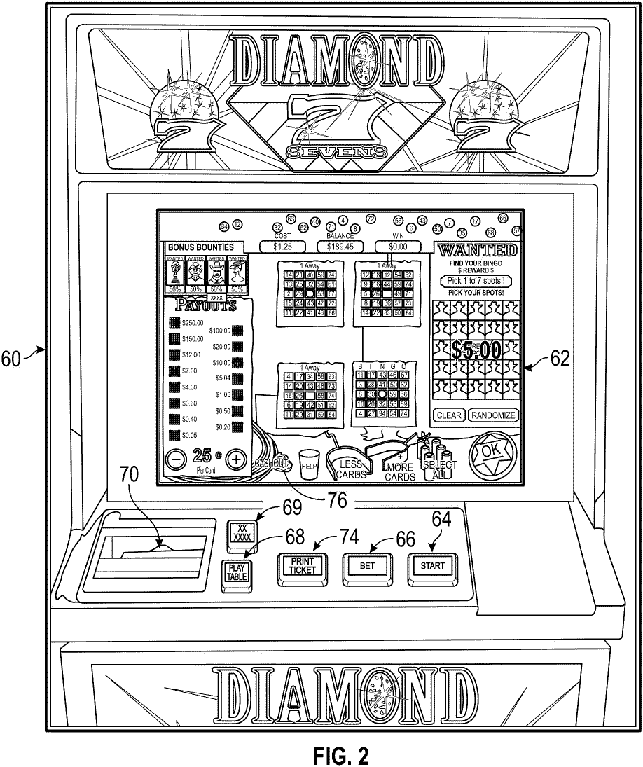

Turning now to FIG. 2, an example bingo cabinet 60 is illustrated, which resembles several known video gaming machines. As can be seen, cabinet 60 includes a display screen 62 which is capable of presenting images and options to the player/user. Additionally, bingo cabinet 60 includes several operator buttons or interface buttons, which are configured to achieve various functions or display additional information. In this particular embodiment, bingo cabinet 60 includes a start button 64 and a bet button 66, both of which are utilized in game play situations. Additionally, a pay table button 68 is available, which will allow display screen 62 to present pay tables applicable to the various games for the user’s benefit. Additionally, an attendant call button 69 is provided which will allow the user to seek assistance if necessary.

Bingo cabinet 60 is also equipped with printer 30 (not shown), which has a printer output 70 positioned on a user console area. As will be appreciated, printer 30 is utilized to provide several printing functions including the printing of paper tickets or paper bingo cards as necessary. On the bingo cabinet console, a print ticket button 74 is provided which also allows for printing operations to be initiated.

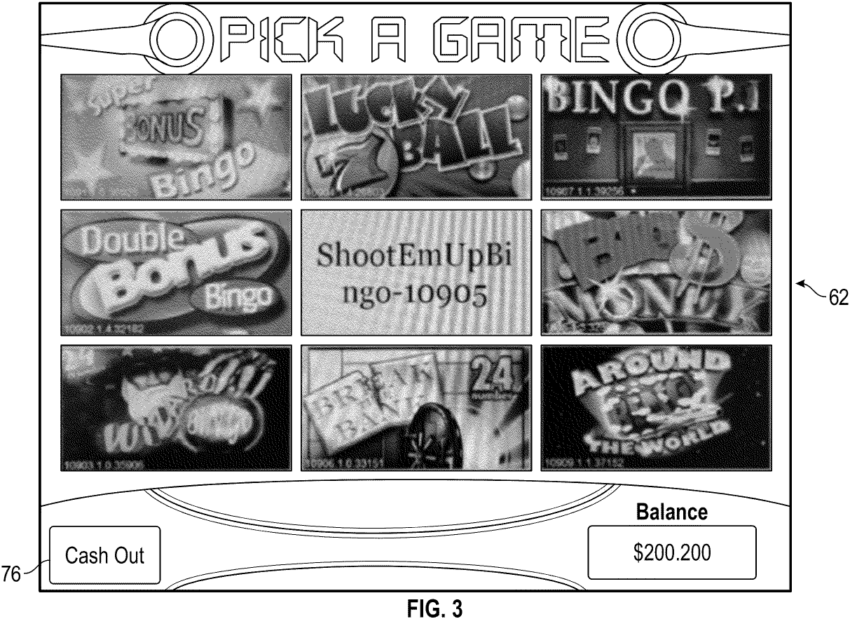

As mentioned above, display cabinet 60 includes a display screen 62 for communicating various types of information. It will be understood that display screen 62 is often a touchscreen itself, and thus provides an additional mechanism for the user to interact with gaming cabinet 60. While FIG. 2 illustrates one potential display screen, many variations are possible. In this embodiment, the display screen 62 of FIG. 3 presents multiple gaming options or variations for selection by the user. Again, display screen 62 is a touchscreen in this instance, thus allowing the user to initiate any of these games by simply selecting the appropriate area displayed on the screen.

Referring again to FIG. 2, several additional play buttons are available to the user. For example, a cash out button 76 is provided in the lower left portion of this display, thereby allowing users to initiate this function. The cash out button 76 is relatively self-explanatory, which provides the user with the ability to cash out when desired. Although not specifically illustrated in this instance, it is contemplated that electronic bingo unit 50 would have a similar display screen, capable of providing the same type of user interface.

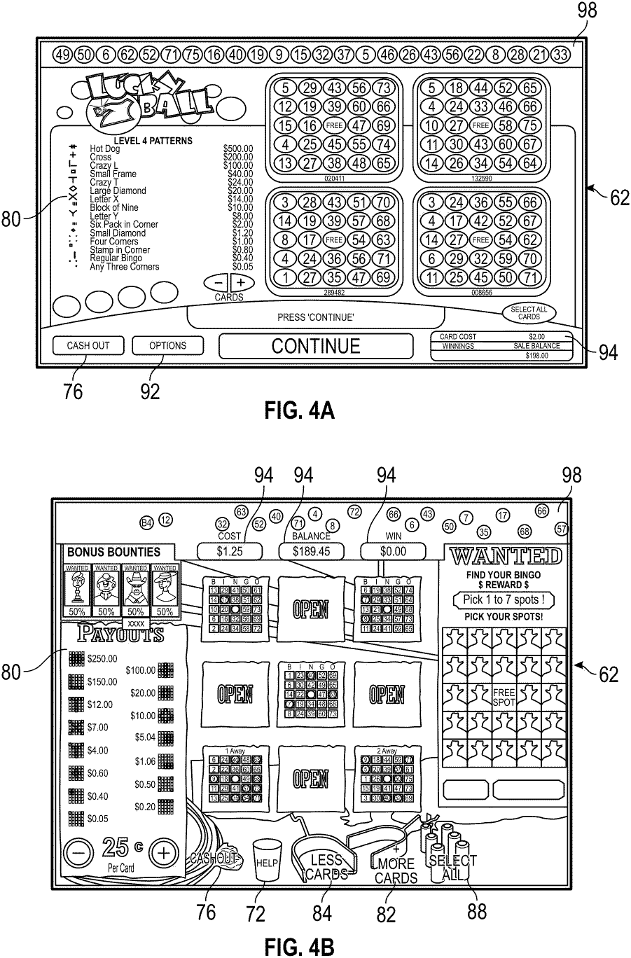

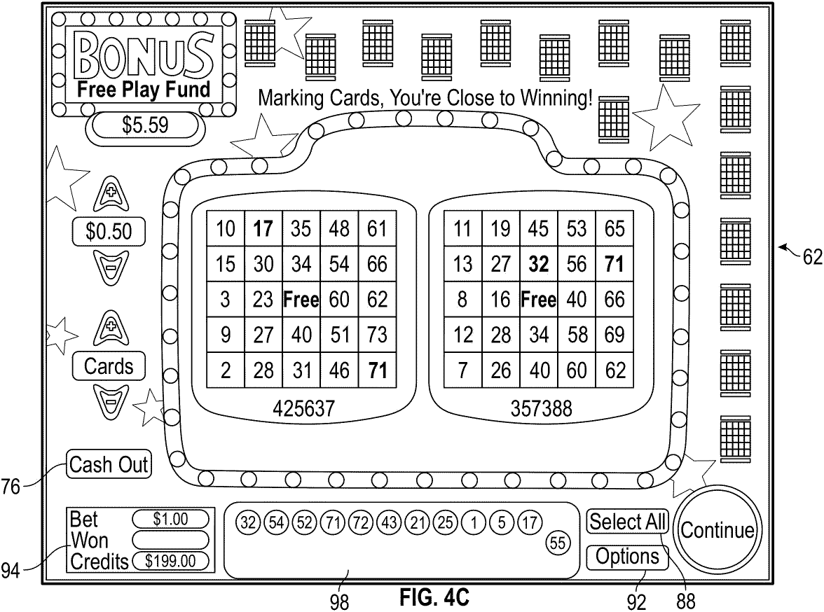

As mentioned above, the gaming system disclosed herein includes the ability to initiate and play several bingo games. The potential options and themes could vary greatly and the presentation of play screens is also widely variable. Three exemplary options are illustrated in FIGS. 4A, 4B and 4C. In each case, it will be seen that various bingo cards are displayed, along with various themes and different options. In each of these variations, a user is presented with physical buttons or touchscreen buttons to carry out several desired functions. In addition, certain display areas will present information to users related to the play of the bingo game(s). Again, the user will have a cash out or pay out button 76 for a user to obtain a cash payout or the receipt of a payout ticket redeemable at another location, or useable at additional machines. Additionally, there are more cards buttons 82 or less cards buttons 84 to present more play cards to the user. Some embodiments include a select all button 88. In many cases, this will allow a user to enter all betting options. Those familiar with the play of bingo will recognize that multiple winning patterns are possible, depending on the game rules being followed. In the examples shown in FIGS. 4A-4C the winning patterns and related payouts are presented the user in a payout screen 80. It is contemplated that the select all button 88 will allow the user to place bets on each of these variations. Display 62 also includes an options button 92 to allow certain display options to be modified. Also presented is a status screen 94 that presents winnings, current credits, etc.

Since the game of bingo involves the selection of numbers, a number display 98 which presents the numbers that have been selected. This will show the status of the bingo game(s) being played and provide useful information to the user.

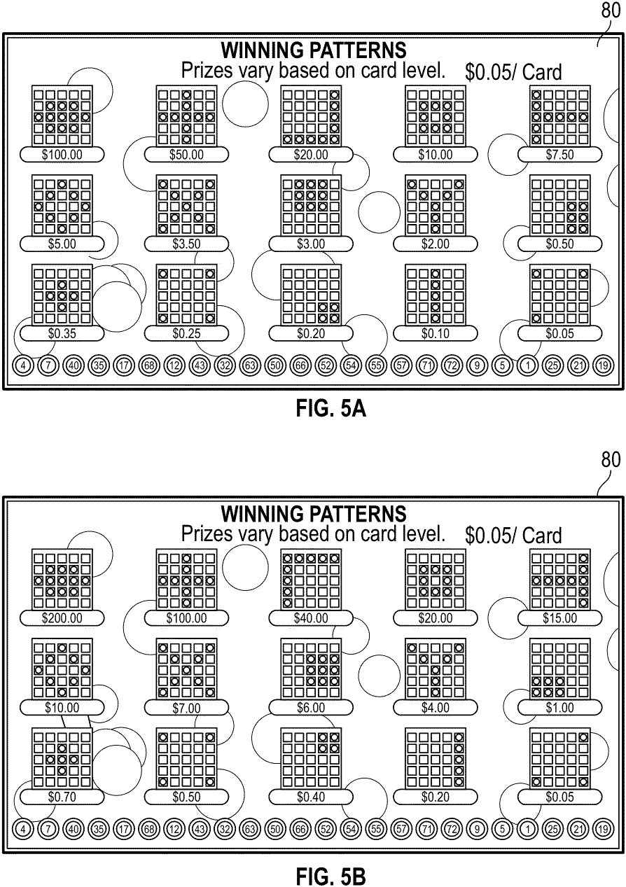

Again, those familiar with various bingo games will also recognize that winning combinations can greatly vary depending on the game and rules incorporated. FIGS. 5A and 5B illustrate one variation or possible set of variations for the desired winning combinations. As will be anticipated, the payout amounts and desired use of multiple patterns will vary from game to game; however, this does provide significant entertainment value and variation to the users. On this screen, the user is also able to see the potential payout amounts if the wager amounts are changed.

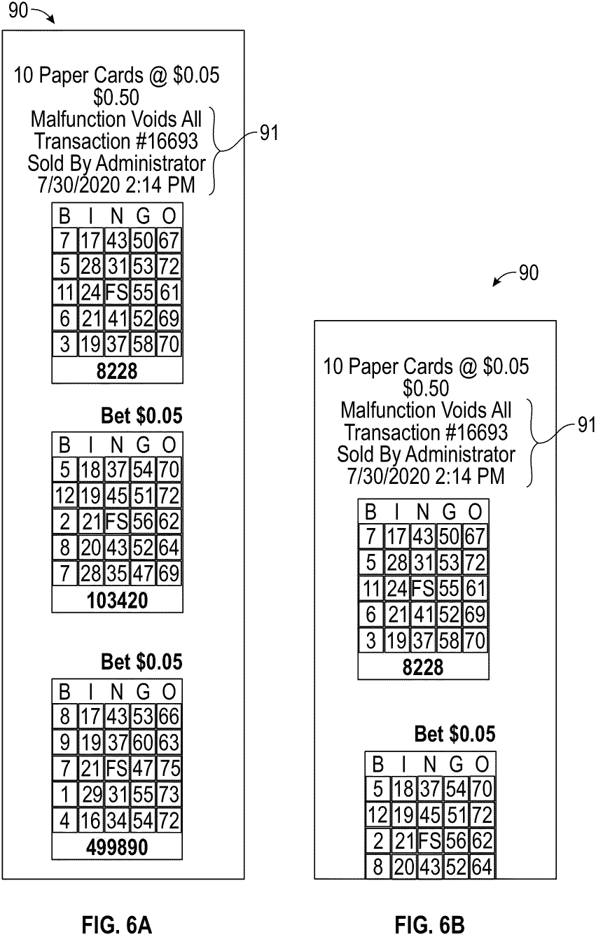

As also mentioned above, one feature of the present bingo system is the inclusion of both electronic and paper game play options. FIGS. 6A and 6B illustrate a paper ticket or printed ticket 90 provided to a user upon request. In this particular embodiment, it is contemplated that the printed ticket 90 is provided at printer output 70 upon request from the user. As seen, the typical printed bingo card will utilize a well-recognized and understood format. In this case, this allows a user to physically mark their own bingo cards as the game progresses or is played out. As will be appreciated, several variations on the format and layout of the printed bingo cards is possible. That said, the layout will always include the typical 5×5 (25-square) grid, although other variations are possible, such as a 7×7 grid including additional number possibilities. The card will also include card detail information 91 that can be confirmed by machines upon receipt. Although not shown in FIGS. 6A & 6B, it is possible that that detail information 91 can be provide in a bar code or QR code format.

It is contemplated that the present system can accommodate game play and various options including the well-known 75-number bingo draw format. Additionally, the system is capable of supporting and accommodating 24-number or wildcat bingo as desired by the gaming host.

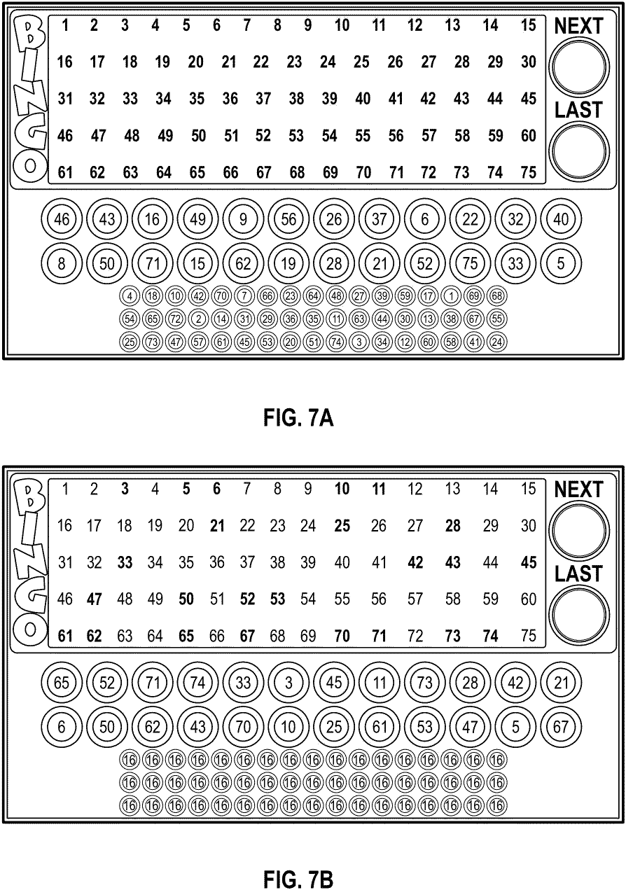

As mentioned above, the display system 20 which could be utilized by the gaming system or server 10 provides several options for a presentation of information to players/users. FIGS. 7A and 7B illustrate one example of a display screen utilized for illustrating the ball drop process or ball drop information as the game is played out. FIG. 7A illustrates a completed screen once a 75-number ball drop process has been completed. As illustrated here, all of the numbers in the upper portion of the display relating to the B-line, I-line, N-line, G-line and O-line have been illustrated since they all have been dropped. The lower portion illustrates the order in which balls were selected or dropped in this instance. FIG. 7B similarly illustrates a 24-ball drop. Again, the upper portion illustrates the numbers that have been drawn, while the lower portion illustrates the order in which these numbers fell.

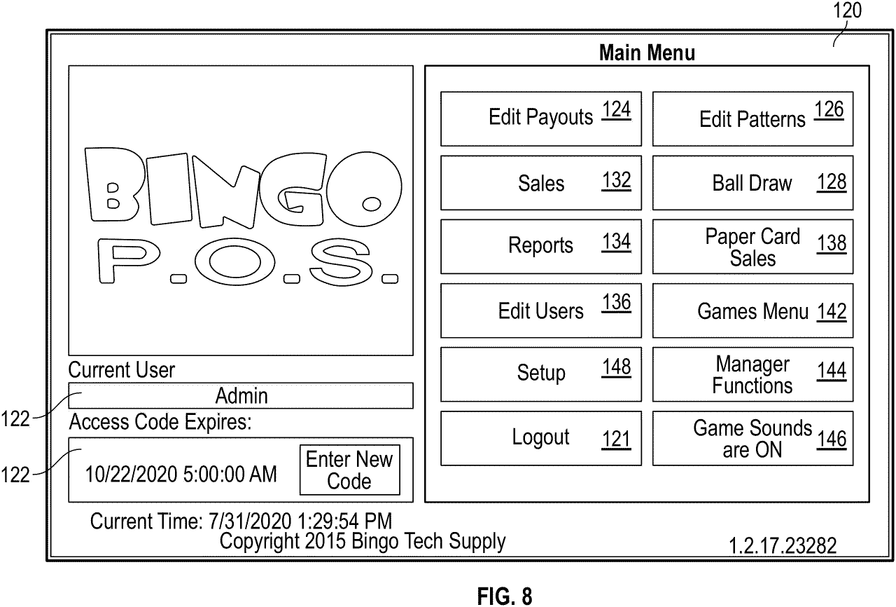

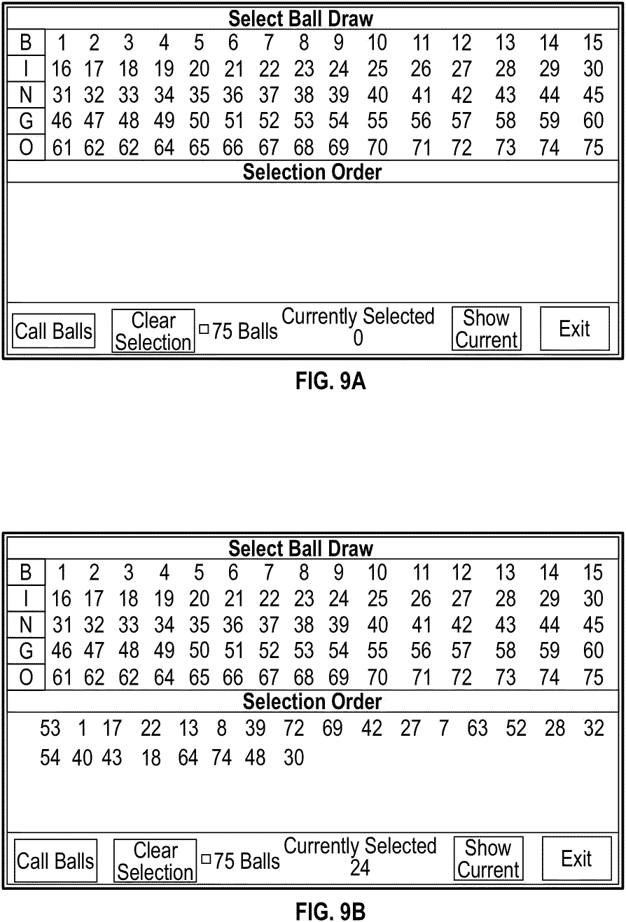

Turning now to FIGS. 8 and 9, various administrative screens are presented. More specifically, FIG. 8 illustrates an administrative screen allowing a game operator to initiate and display certain game information. This also allows for certain administrative processes such as setups, reports, sales amounts, etc. Clearly, other options or alternatives are possible using this screen. As shown in this embodiment, administrator login information 122 can be entered, and login status is shown. Also presented to the administrator are buttons that allow a user to edit payouts 124, edit payout patterns 126 and change the characteristics of the ball draw process 128. The administrator can also see reports on sales 132, see operation reports 134, and review paper card sales 138. The system also a games menu button 142 that allows an administrator to change game options available to the user. A general setup button 148 will allow an administrator to change other system setup options. A related manager functions button 144 exists to allow further management details such as the way multiple machines are coordinated, etc. Game sounds can be managed using sounds button 146 in a similar manner. In each case, related screens are brought up allowing the administrator to make the necessary modifications. Last, logout button 121 is presented to the administrator to end access to functions.

Similarly, FIGS. 9A and 9B illustrate game operation screens available to game administrators. More significantly, this allows operators to call for new ball drops, alter the desired ball drop process and to monitor the process or progress of the ball drop systems. As will be appreciated, the ball drop process is managed electronically and carried out in server 10. In the example illustrated in FIG. 9B, a 24-ball game has been initiated, and the administrator can see which balls have been dropped in each row.

In certain instances, it is more exciting and desirable to have physical ball draw processes or mechanisms utilized. FIG. 10 illustrates three options for physical ball drop or ball selection mechanisms. In this illustration, a manual ball tumbler 100 is shown, which is capable of carrying out the physical process of selecting balls and calling a bingo game. In this case, there is no connection to server 10, thus information about the ball drop must be done manually. In a similar manner, a ball scanner 102 can be added for use in conjunction with the manual ball tumbler 100 to provide automated manner, thus eliminating any necessary manual interaction. In this instance, it is contemplated that ball scanner 102 would have a wired or wireless connection to server 10, thus allowing for the automatic monitoring of numbers as drawn.

In certain instances, especially where specialized 24-ball bingo games are carried out, it is desirable to segregate the ball selection process so that five numbers in the B category are chosen, five numbers in the I category are chosen, four numbers in the N category are chosen, five numbers in the G category are chosen, and lastly five numbers in the O category are chosen. To accommodate this type of game play, a segregated ball tumbler 120 is utilized. In this particular instance, it is contemplated that a segregated tumbler 120 will have five separate chambers, each dedicated to one of the above categories. In this manner, the specialized or very tailored ball drop process can be accomplished. It is further contemplated that that scanner 102 could be used in conjunction with the segregated tumbler 120.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A system for coordinating the play of an automated multi-format bingo game, the system comprising:
a central controller configured to coordinate the play of the multi-format bingo game;
a display coupled to the central controller configured to present information to a user;
a user interface coupled to the central controller operable by a user to select predetermined options for the play of the multi-format bingo game;
an electronic gaming mechanism configured to allow players to participate in the multi-format bingo game electronically;
a printer for providing printed elements, thereby allowing users to participate in the multi-format bingo game using physical marking instruments;
a scanner coupled to the central controller configured to read the printed elements and provide information back to the central processor indicative of the status of the printed element; and
an administrator interface allowing an administrator to configure and monitor the play of the multi-format bingo game.

2. The system of claim 1 wherein the electronic gaming mechanism is an electronic bingo unit which will communicate with central processer, wherein the electronic bingo unit is enabled by a printed card produced by the printer.

3. The system of claim 1 wherein the electronic bingo unit is further configured to obtain electronic bingo cards and accommodate the play of bingo in an electronic format.

4. The system of claim 1 further comprising a ball drop mechanism to coordinate the selection of balls for play of the bingo game.

5. The system of claim 4 wherein the ball drop mechanism further includes a communication mechanism configured to communicate the selection of balls to the central controller thereby allowing the central controller to coordinate play of the multi-format bingo game.

6. The system of claim 5 wherein the multi-format bingo game is a 24 ball bingo game.

7. The system of claim 5 wherein the multi-format bingo game has a plurality of winning patterns and the completion of one of the plurality of winning patterns creates a winning payout.

8. The system of claim 7 wherein any of the winning payouts are coordinated by the central controller and winning payouts are made by a payment coordination system.
